(19) United States
(12) Patent Application Publication
(10) Pub. No.: US 2011/0099128 A1
(43) Pub. Date: Apr. 28, 2011

(54) Method of Production and Use of Ethane Gas

(76) Inventor: Michael K. Weaver, Erie, PA (US)

(21) Appl. No.: 12/908,098

(22) Filed: Oct. 20, 2010

Related U.S. Application Data
(60) Provisional application No. 61/255,118, filed on Oct. 27, 2009.

(51) Int. Cl. F23C 99/00; G06Q 90/00; B01D 1/00

(52) U.S. Cl. 705/500; 431/2; 95/251

(57) ABSTRACT

The within invention provides a method of producing and utilizing ethane gas, mostly a waste product from natural gas wells, especially Marcellus Shale wells in the northeastern United States. The method provides for separating the ethane gas from the natural gas wells, preparing it and mixing it with methane gas to burn landfill waste on site at a landfill's incinerator. Other components of the natural gas well, such as propane, butane and hexanes are further separated and sold to commercial and residential end users.

### CROSS-REFERENCE TO RELATED APPLICATIONS

The present application claims the benefit of U.S. Provisional Application No. 61/255,118 filed on Oct. 27, 2009, which is incorporated herein by reference.

### FEDERALLY SPONSORED RESEARCH

Not Applicable

### BRIEF DESCRIPTION OF THE DRAWINGS

These and other features, aspects and advantages of the present invention will become better understood with regard to the following description, appended claims, and accompanying drawings where:

FIG. 1 is a pie chart showing the hydrocarbon composition of a typical shallow well.

FIG. 2 is a pie chart showing the hydrocarbon composition of a typical Marcellus Shale well.

FIG. 3 is a flowchart representing a typical Extraction Plant as described in the within invention.

FIG. 4 is a flowchart representing the Fractionation Process as described in the within invention.

### DESCRIPTION

Natural gas is an essential energy source in the United States. It is one of the cleanest, safest and most useful of all energy sources. It is used both commercially and residentially and is a major source of energy for the power generation industry.

Natural gas extracted from the ground is made up primarily of methane gas. Raw natural gas exists in mixtures with other hydrocarbons, such as ethane, propane, butane and pentanes. These other hydrocarbons are in vapor and liquid form. Typically, raw natural gas from shallow wells is composed of the following components:
80% methane
12% ethane
4% propane
4% other hydrocarbons

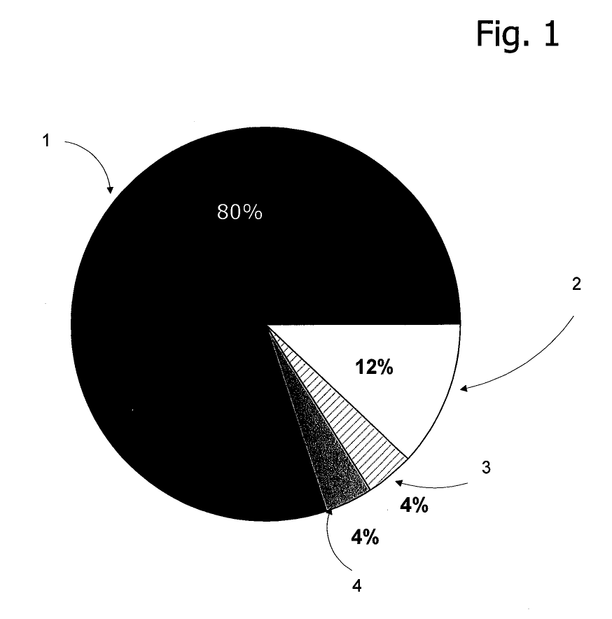

FIG. 1 is a pie chart representing the breakdown of the components of raw natural gas from shallow wells. Methane 1 comprises 80% of the natural gas from shallow wells. Ethane 2 makes up 12% and propane 3 makes up 4%. The final 4% is made up of other hydrocarbons 4 such as butane and pentanes.

Marcellus Shale natural gas fields which are typically found primarily in the northeastern United States yield a natural gas that has a slightly (but economically significant) different makeup of hydrocarbons than that of shallow wells:
79% methane
14% ethane
4% propane
3% other hydrocarbons

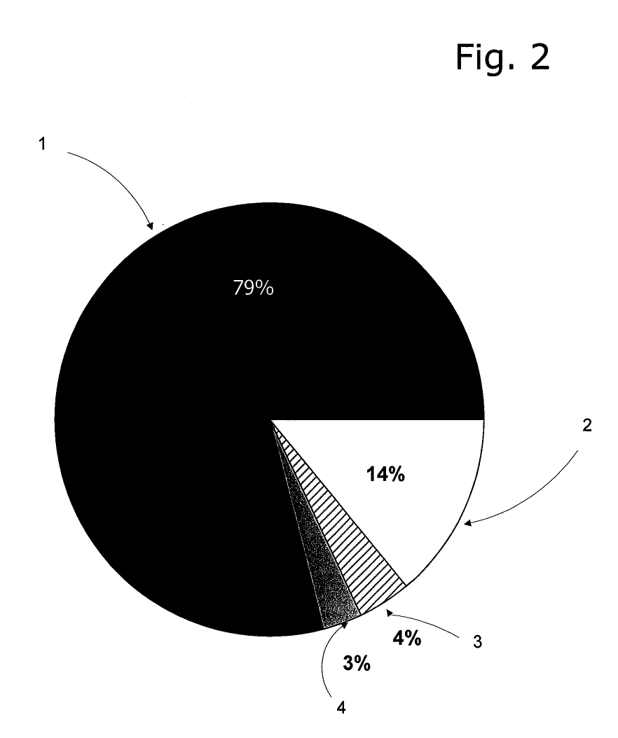

FIG. 2 is a pie chart showing the breakdown of the components of Marcellus Shale natural gas fields as found typically in the northeastern United States. Methane 1 comprises 79% of the natural gas from Marcellus Shale wells. Ethane 2 makes up 14% and propane 3 makes up 4%. The final 3% is made up of other hydrocarbons 4 such as butane and pentanes.

Thus, by comparing FIGS. 1 and 2, it is clear that Marcellus Shale natural gas fields yield significantly more ethane than what is typically found in raw natural gas from shallow wells. In the natural gas industry, ethane is looked upon as a waste product rather than a viable source of energy. Accordingly, the within invention proposes to utilize this “waste product” which is typically found in higher concentrations in Marcellus Shale deposits, and turn it into a readily available source of energy.

Prior to any raw natural gas being transported via pipeline, it must be processed at or near the well head through a field processing “Extraction Plant.” The Extraction Plant removes the various hydrocarbons from the methane gas, which are also referred to a “Y-grade liquids.” The methane is sent directly to the gas pipeline for commercial and residential sales.

This extraction process recovers a large percentage of the ethane in the gas stream, along with the other hydrocarbons. A small percentage of ethane can be re-introduced into the sales gas stream (which is made up primarily of methane); however, great care must be taken that the pipeline content does not exceed imposed restrictions on the final gas composition. Regulations require that the natural gas pipeline have a British Thermal Unit (“BTU”) value maximum of 1,100 BTU with an average value of 1,000 BTU. The normal expected BTU from methane is 1,000 and the normal expected BTU of ethane is almost 1,800. Thus, by adding too much ethane to the methane gas pipeline, the overall BTU will be too high and unusable for either commercial or residential use.

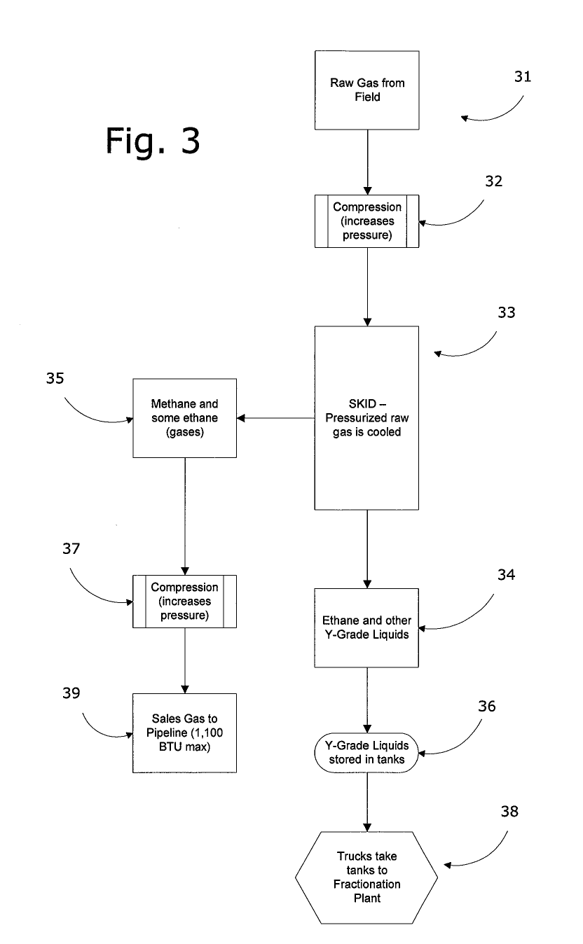

FIG. 3 is a flowchart showing a typical Extraction Plant process. First, raw gas is received from the field 31 and then compressed 32. The compressed raw gas then is sent to a skid 33 where the gas is then cooled. The gases methane and ethane 35 are then taken from the top of the skid 33 while ethane and other Y-grade liquids 34 are removed from the bottom of the skid 33. The methane and ethane gases 35 are then compressed 37 to increase pressure, adjusted to a BTU of less than 1,100 and then sent to the pipeline 39 for sales to customers. The ethane and Y-grade liquids 34 are then stored in tanks 36 and then transported by truck (or train) 38 to a Fractionation Plant.

Typically, once the Y-grade liquids are removed from the raw natural gas stream by extraction, this liquid must be further separated down into their base components (e.g., ethane, propane, butane and pentanes). These separated components have a higher market value than they do as part of the Y-grade liquid. The Y-grade liquids are broken down by a Fractionation Process.

Under most circumstances, current technologies and distribution modalities utilize virtually all of the propane and butane from the Y-grade liquid. As previously stated, ethane can sometimes be added back into the natural gas pipeline, but only in limited amounts due to its high BTU value. To further compound the ethane problem, the only current alternative to ethane use (other than being added back into the natural gas pipeline) is to mix the ethane with the Y-grade liquids for further processing at a fractionation facility. However, shipments to fractionation facilities that exceed 4% ethane are either rejected or the extraction plant is penalized creating additional cost. Accordingly, current stocks of Marcellus Shale Y-grade liquid are ripe with ethane that has no real substantive market for its use.

One embodiment of the current invention is applicable in the landfill industry. The ethane gas is mixed with a landfill's waste gas stream (usually primarily composed of methane) and sent to an incinerator or flare to burn residual and commercial waste products at the landfill or to help burn afluents separated from the landfill gases.

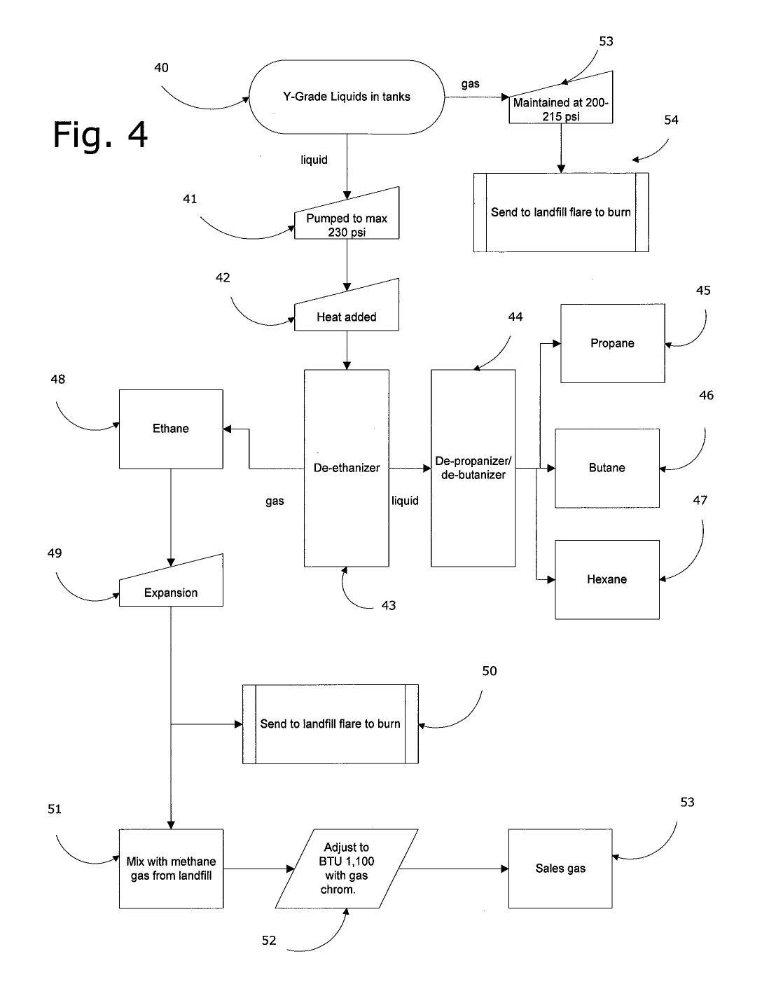

The method of the current invention requires that ethane-laced Y-grade liquid be transferred to a fractionation facility near or at a landfill via truck or train. As set forth in FIG. 4, at the landfill, the Y-grade liquid is deposited into storage tanks 40.

The vapor from the Y-grade liquid (made up primarily of ethane and traces of propane) is maintained 53 at 200 to 215 pounds per square inch to control boil off and is then sent directly to the landfill's flares 54 for incineration of landfill materials.

The Y-grade liquid is pumped 41 to a maximum pressure of 230 pounds per square inch. Then it is pumped into a heating unit 42 and heated to 150 degrees Fahrenheit. The heated fluid then passes into a de-ethanizer tower 43 where ethane 48 is vaporized out of the fluid. Once the ethane is separated out as a gas, natural expansion occurs 49. The ethane gas can then be mixed with methane gas 51 which originates from the landfill itself. The mixture is then adjusted to achieve a BTU level 52 of 1,100, which yields a temperature of 1,600 to 2,100 degrees Fahrenheit. A gas chromatograph is used to read the BTU of the mixture. This mixture is then sent to customers as sales gas 53. The mixture can be sent directly to a stream to mix with other gasses for use as a fuel in many industries. Ethane not mixed with methane is simply sent to the landfill 50 for use in flare burn.

The liquid product resulting from the de-ethanizer process 43 is then further fractionated in a de-propanizer/de-butanizer 44. This fractionation will make pure propane 45, pure butane 46 as well as hexanes 47 for wholesale commercial and residential sales of propane and butane.

Thus, by using ethane to aid in the incineration process, a landfill can decrease its reliance on methane it gets from the gas pipeline and realize a decrease in its incineration costs.

From the descriptions above, a number of advantages of the methods become evident:
1. An easy, efficient and cost-effective way to use ethane from natural gas wells,
2. A way of utilizing ethane which is usually a waste product of natural gas to incinerate landfill waste,
3. A way to decrease consumption by a landfill of methane (or other natural gases) to incinerate its waste products, and
4. Another way of introducing high BTU ethane into the natural gas pipeline after utilizing much of the ethane to incinerate landfill waste.

I claim:

1. A method of producing ethane gas comprising:
(a) obtaining Y-grade liquids from the field;
(b) adding pressure to said liquids;
(c) adding heat to said liquids;
(d) passing the heated liquid through a de-ethanizer tower;
(e) extracting the ethane gas; and
(f) adding pressure to said ethane gas.

2. The method for utilizing ethane gas according to the method of claim 1 comprising the additional step of:
sending said ethane gas directly to a landfill site flare to incinerate landfill waste.

3. The method for utilizing ethane gas according to the method of claim 1 comprising the additional steps of:
(a) mixing said ethane gas with methane gas obtained from the landfill;
(b) adjusting said mixture to a maximum BTU of 1,100; and
(c) sending said mixture to sales gas line for sales to customers.

4. A method for utilizing ethane gas comprising:
(a) obtaining Y-grade liquids from the field;
(b) separating the ethane gas from said Y-grade liquids;
(c) maintaining the pressure of said ethane gas at 200 to 215 pounds per square inch; and
(d) sending said ethane gas to a landfill site flare to incinerate landfill waste.

5. A method for producing ethane gas comprising:
(a) means for obtaining ethane and other natural gasses from ground wells;
(b) means for separating ethane from the other said natural gasses; and,
(c) means for burning landfill materials with said ethane.

6. A method for producing and utilizing ethane gas comprising:
(a) means for obtaining ethane and other natural gasses from ground wells;
(b) means for separating ethane from the other said natural gasses;
(c) means for mixing said ethane with methane to obtain an acceptable BTU; and,
(d) means for selling said mixture to customers.
